(19) United States
(12) Patent Application Publication
(10) Pub. No.: US 2008/0111794 A1
(43) Pub. Date: May 15, 2008

(54) Timepiece with handwriting input unit

(75) Inventors: Tung-Chih Wu, Yonghe City (TW); Hung Jia Wang, Yonghe City (TW)

Correspondence Address: RABIN & Berdo, PC, 1101 14TH STREET, NW, SUITE 500, WASHINGTON, DC, 20005, US

(73) Assignee: MOD DESIGN DEVELOPMENT LTD.

(21) Appl. No.: 11/599,593

(22) Filed: Nov. 15, 2006

(51) Int. Cl. G06F 3/041

(52) U.S. Cl. 345/173

(57) ABSTRACT

A timepiece includes a micro control unit, to which a display unit, a timekeeping unit, a sound emitting mechanism, and a handwriting input unit are connected. The handwriting input unit is formed of a carbon powder layer, a duplicating layer, and a sensing circuit layer. Numerical characters indicating an alarm time may be directly handwritten on the handwriting input unit and identified by the sensing circuit layer, so that a signal is sent from the handwriting input unit to the micro control unit. When the timekeeping unit reaches at a time matching with the handwritten input alarm time, the micro control unit sends a signal to the sound emitting mechanism for the same to emit a sound. Therefore, a user may quickly and conveniently complete an alarm set on the timepiece.

### FIELD OF THE INVENTION

The present invention relates to a timepiece with handwriting input unit, and more particularly to a timepiece that allows a user to handwrite characters on a handwriting input unit, so as to very easily and conveniently input and set an alarm time for the timepiece.

### BACKGROUND OF THE INVENTION

In a conventional alarm clock, a mechanical type “hand” is turned to set a time for emitting an alert sound. When the set alarm time is reached, related internal components are actuated, so that a sound emitting mechanism emits sound. The alarm clock with the above-described alarm time setting structure might very possibly have a failed alarm module due to improper mechanism design or improper operating manner.

There are also electronic alarm clocks and watches, which require complicate procedures and a lot of time to correctly set a desired alarm time.

Moreover, all the currently available alarm clocks are generally set to alarm in the above mentioned manners without special changes.

Therefore, it is desirable to develop a timepiece that can be set to alarm in a novel and convenient manner.

### SUMMARY OF THE INVENTION

A primary object of the present invention is to provide a timepiece with handwriting input unit, so that a user may handwrite numerical characters on the handwriting input unit to very easily and conveniently input and set an alarm time for the timepiece.

Another object of the present invention is to provide a timepiece with handwriting input unit, which also includes a temperature sensing element for sensing an ambient temperature, so that the timepiece also provides information about ambient temperature.

To achieve the above and other objects, the timepiece with handwriting input unit according to the present invention includes a micro control unit (MCU) for controlling the movements of all other components of the timepiece; a timekeeping unit connected to the micro control unit; a display unit connected to the micro control unit for showing a message sent thereto by the micro control unit; a handwriting input unit connected to the micro control unit for inputting a handwritten instruction; and a sound emitting mechanism connected to the micro control unit for receiving a signal from the micro control unit and emitting a sound.

The micro control unit is internally provided with a temperature sensing element for sensing an ambient temperature, which is then sent to the micro control unit and shown on the display unit.

In a preferred embodiment, the timepiece is provided with a control button, which is connected to the micro control unit. When the timepiece emits sound, the control button may be pushed to delay the sounding of the timepiece.

In an ideal embodiment, the handwriting input unit is formed of a carbon powder layer, a duplicating layer, and a sensing circuit layer. The sensing circuit layer is an identifying system having a sensing circuit, which uses an internally preset identifying module to identify handwritten characters sequentially input via the handwriting input unit.

A user may use the handwriting input unit to quickly and conveniently input and set an alarm time through handwriting without involving in complicate setting procedures. Therefore, the timepiece of the present invention is indeed a novel technical design practical and convenient for use.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a timepiece with handwriting input unit according to the present invention;

FIG. 2 is a block diagram of a timepiece with handwriting input unit according to a first embodiment of the present invention;

FIG. 3 is a block diagram of a timepiece with handwriting input unit according to a second embodiment of the present invention;

FIG. 4 is a flowchart showing the operation of an identifying system included in the timepiece of the present invention;

FIG. 5 is an enlarged sectional view showing the structure of a handwriting input unit included in the timepiece of the present invention;

FIG. 6 shows the manner of inputting and setting an alarm time via the handwriting input unit on the timepiece of the present invention;

FIG. 7 shows a first example of resetting the timepiece of the present invention via a magnetic reed switch; and

FIG. 8 shows a second example of resetting the timepiece of the present invention via a magnetic reed switch.

### DETAILED DESCRIPTION OF THE PREFERRED EMBODIMENTS

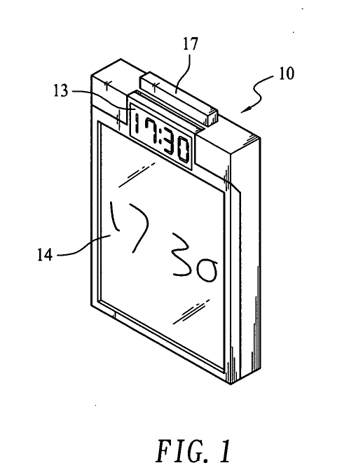

Please refer to FIGS. 1 through 5, in which a timepiece with handwriting input unit 10 according to the present invention is shown. As shown, the timepiece 10 includes a micro control unit (MCU) 11 for controlling the movements of all other components of the timepiece 10; a timekeeping unit 12 connected to the micro control unit 11; a display unit 13 connected to the micro control unit 11 for showing a message sent thereto by the micro control unit 11; a handwriting input unit 14 connected to the micro control unit 11 for inputting a handwritten instruction; and a sound emitting mechanism 15 connected to the micro control unit 11 for receiving a signal from the micro control unit 11 and emitting a sound.

Wherein, the micro control unit 11 is a microprocessor chip.

The micro control unit 11 is internally provided with a temperature sensing element 16 for sensing an ambient temperature, which is then sent to the micro control unit 11 and shown on the display unit 13.

In a preferred embodiment, the timepiece 10 is provided with a control button 17, which is connected to the micro control unit 11. When the timepiece 10 emits sound, the control button 17 may be pushed to delay the sounding of the timepiece 10.

In an ideal embodiment, the handwriting input unit 14 is formed of a carbon powder layer 141, a duplicating layer 142, and a sensing circuit layer 143. The sensing circuit layer 143 is an identifying system having a sensing circuit, which uses an internally preset identifying module to identify handwritten characters sequentially input via the handwriting input unit 14.

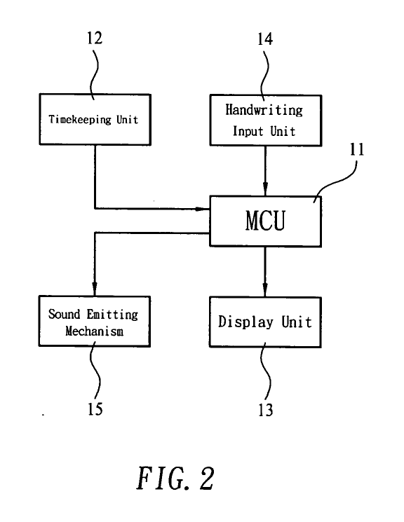

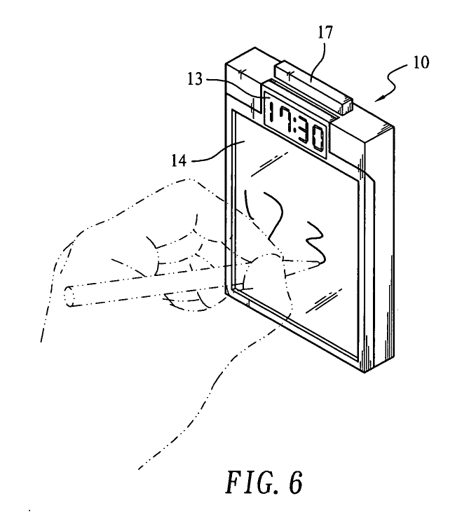

Please refer to FIGS. 2 through 6. A user may directly handwrite some characters on the handwriting input unit 14 to input a specific alarm time for the timepiece 10. The input characters are sequentially identified by the sensing circuit layer 143, and information from the identifying is sent to the micro control unit 11. When a time indicated by the timekeeping unit 12 matches with the specific alarm time set for sounding, the micro control unit 11 sends a signal to the sound emitting mechanism 15, so that the sound emitting mechanism 15 is actuated to emit a sound to waken or remind a user.

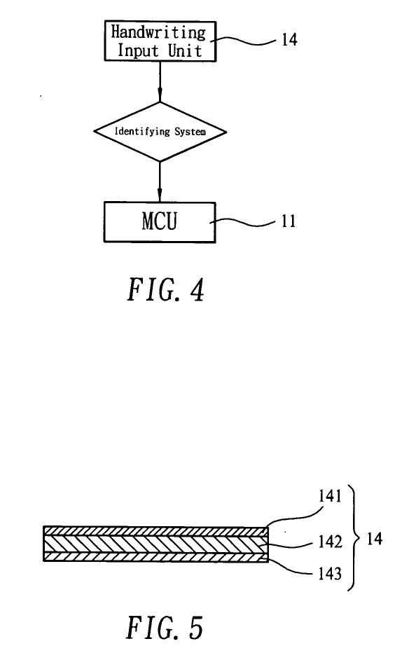

Please refer to FIGS. 4 and 5 again. The handwriting input unit 14 identifies the handwritten input characters via the carbon powder layer 141, the duplicating layer 142, and the sensing circuit layer 143. The module internally set in the sensing circuit layer 143 divides a sensing area of the handwriting input unit 14 into four sub-areas, so that all the numerical characters sequentially input the sub-areas can be identified by the sensing circuit layer 143. It is not necessary to identify the characters one at a time. That is, multiple characters may be directly sequentially identified at one time. With the carbon powder layer 141 and the duplicating layer 142, the handwritten characters input via the handwriting input unit 14 may be shown for the user to ascertain the input time is correct.

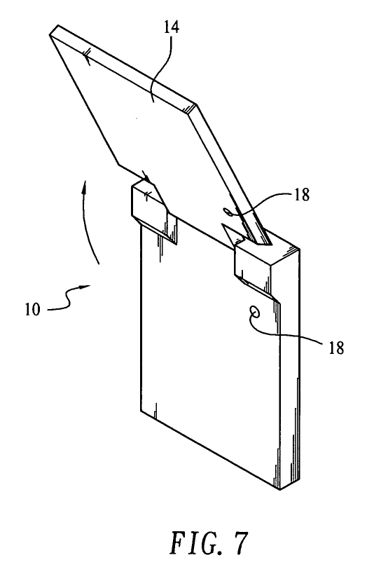

As can be seen from FIG. 7, a magnetic reed switch 18 is provided on contact surfaces between the timepiece 10 and the handwriting input unit 14. The magnetic reed switch 18 is connected to the micro control unit 11. When it is desired to reset the time for emitting the alert sound, simply lift the handwriting input unit 14 and the magnetic reed switch 18 is actuated to send a signal to the micro control unit 11, so as to erase an earlier time setting or a wrongly input characters to enable input of a new time setting for emitting an alert sound.

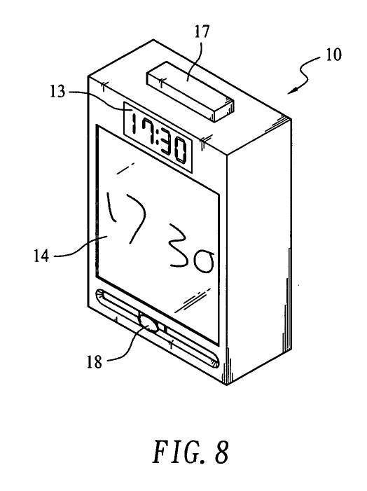

FIG. 8 shows another example of the magnetic reed switch 18. In this example, the magnetic reed switch 18 is provided on a front of the handwriting input unit 14. By sliding the magnetic reed switch 18 along a predetermined path, the characters handwritten on the handwriting input unit 14 may be erased to enable input of a new time setting for emitting an alert sound.

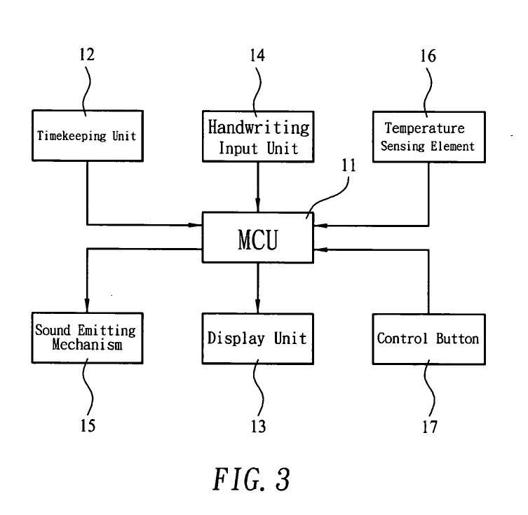

As can be seen from FIG. 3, a temperature sensing element 16 may be additionally provided and connected to the micro control unit 11 for sensing an ambient temperature, which is then shown on the display unit 13. The control button 17 may be used to delay the alert sound emitting time until the handwriting input unit 14 is lifted to actuate the magnetic reed switch 18, and the timepiece 10 is put into a state not to emit sound.

When the handwritten characters are input and the micro control unit 11 receives and verifies a signal from the handwriting input unit 14, an instruction is sent by the micro control unit 11 to the sound emitting mechanism 15. After the instructed time is set in the sound emitting mechanism 15 by internal modules thereof, the exact time for emitting the alert sound may be correctly returned and reported to the micro control unit 11.

With the handwriting input unit 14 provided on the timepiece 10, a user may intuitionally and quickly input and set an alarm time via the handwriting input unit 14 without involving in complicate setting procedures that would otherwise occur in other types of alarm watches or clocks. And, an earlier setting may be conveniently erased via the magnetic reed switch 18.

Therefore, the timepiece 10 of the present invention is indeed a novel technical design practical and convenient for use.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A timepiece with handwriting input unit, comprising:
a micro control unit for controlling movements of all other components of said timepiece;
a timekeeping unit connected to said micro control unit;
a display unit connected to said micro control unit for showing a message sent thereto by said micro control unit;
a handwriting input unit connected to said micro control unit for a user to input a handwritten instruction thereon; and
a sound emitting mechanism connected to said micro control unit for receiving a signal from said micro control unit and then emitting a sound.

2. The timepiece with handwriting input unit as claimed in claim 1, wherein said micro control unit is a microprocessor chip.

3. The timepiece with handwriting input unit as claimed in claim 1, wherein said micro control unit is internally provided with a temperature sensing element.

4. The timepiece with handwriting input unit as claimed in claim 1, further comprising a control button connected to said micro control unit.

5. The timepiece with handwriting input unit as claimed in claim 1, wherein said handwriting input unit is formed of a carbon powder layer, a duplicating layer, and a sensing circuit layer.

6. The timepiece with handwriting input unit as claimed in claim 1, wherein said handwriting input unit includes a magnetic reed switch.
